(19) United States
(12) Patent Application Publication
(10) Pub. No.: US 2011/0258671 A1
(43) Pub. Date: Oct. 20, 2011

(54) Digital Television Receiving Terminal, Positioning Method and System Thereof

(75) Inventor: Jiaming Hong, Shenzhen (CN)

(73) Assignee: SHENZHEN COSHIP ELECTRONICS CO. LTD., Shenzhen (CN)

(21) Appl. No.: 13/141,084

(22) PCT Filed: Dec. 29, 2009
(86) PCT No.: PCT/CN2009/076166

§ 371 Date: Jun. 21, 2011

(30) Foreign Application Priority Data
Dec. 30, 2008 (CN) 200810241751.7

(51) Int. Cl. H04N 21/45; H04N 7/173

(52) U.S. Cl. 725/93

(57) ABSTRACT

A digital television receiving terminal, a positioning method and system thereof are disclosed. Wherein the method includes the steps of: locking a frequency point for receiving a program by a user according to the received on-demand signals input by the user; determining a transmission stream identifier code (TSID) of the frequency point in the TSIDs broadcasted by the locked frequency point; and comparing the TSID with a pre-stored area code, and judging whether the locked frequency point for receiving the program by the user is a valid on-demand frequency point, and if so, the positioning is successful. The present invention avoids the needs of scanning and acquiring the area code when demand is performed by the user each time, thus saving the starting up time, and having strong applicability.

This application claims the priority to Chinese Patent Application No. 200810241751.7, filed with the Chinese Patent Office on Dec. 30, 2008 and entitled “A Digital Television Receiving Terminal, Positioning Method and System”, which is hereby incorporated by reference in its entirety.

### TECHNOLOGY FIELD

The present invention generally relates to a digital network management technology, and in particular to a digital television receiving terminal, its positioning method and system.

### BACKGROUND TECHNOLOGIES

Offering two-way digital television (TV) interactive services to up to tens of millions of users in large and medium-sized cities necessitates a huge distributed network that supports the deployment of system resources and service capabilities. Therefore, it is necessary to locate users and thus provide them with appropriate services.

Currently, set top boxes (STBs) in HFC networks are located between the STBs and their front-end systems through preset rules. The prior art provides two methods to locate the STBs: fixed assignment and real-time down transferring. In real-time down transferring, the area code information is transmitted through IPQAM and the HFC channel to the STB through the preset and real-time broadcast area code and other related parameters. The user STB obtains relevant area codes through resolution based on the preset rules. In the prior art, parameters relating to the area code are set in two modes: TSID or NID.

In the TSID mode, the TSID of each channel in IPQAM is configured in advance according to the frequency band plan and deployment of the system to ensure that the TSID of each transport stream in IPQAM is unique. The user STB acquires in advance a list of determined frequencies, and acquires and stores the TSIDs one by one. In this mode, the user STB will scan and acquire the area code for every service on-demand, thus prolonging startup time and causing poor applicability, especially in scenarios where STBs require quick access to services on-demand after startup.

### CONTENTS OF THE INVENTION

The object of the embodiments of the present invention is to provide a method of positioning digital television receiving terminals, and the embodiments are aimed at providing a solution to the problem of long startup time and poor availability arising from the prior art method of positioning digital television receiving terminals that uses the TSID to set relevant area code parameters and requires user's STB to scan and acquire area codes each time the user starts the STB.

A method of positioning digital television receiving terminals is provided in an embodiment of the present invention. The method comprises:
locking the frequency at which users receive programs according to the received on-demand signal from users;
determining the transmission stream identifier code (TSID) of the frequency in the TSID broadcast by the locked frequency; and
comparing the TSID with the pre-stored area code and judging if the locked frequency is valid; if yes, the positioning is successful.

One object of the embodiment of the present invention is to provide a system for positioning digital television receiving terminals, which comprises:
an on-demand signal receiving unit, configured to receive the on-demand signals from users;
a frequency locking unit, configured to lock the frequency at which users receive programs according to the on-demand signals from users received by the on-demand signal receiving unit;
a frequency area code selecting unit, configured to determine the TSID of the frequency in the TSID broadcast by the locked frequency at which users receive programs; and
a frequency legitimacy judgment unit, configured to compare the TSID determined by the frequency area code selecting unit with the pre-stored area code and judge if the locked frequency is valid; if yes, the positioning is successful.

Another object of the embodiments of the present invention is to provide a digital television receiving terminal, comprising the system for positioning the digital television receiving terminal

According to the embodiments of the present invention, the positioning system, after receiving on-demand signals from users, locks in the frequency at which users receive programs, compares the pre-stored area code with the TSID broadcasted by the locked frequency, and judges if the locked frequency is valid; if yes, the positioning is successful; thereby avoids the trouble of scanning and acquiring the area code each time the user uses the service on-demand, shortens startup time and enhances applicability.

### BRIEF DESCRIPTION OF THE DRAWINGS

FIG. 1 is a flowchart of a method for positioning digital television receiving terminals provided in an embodiment of the present invention; and

FIG. 2 shows a structure of the positioning system provided in an embodiment of the present invention.

### DETAILED DESCRIPTION OF THE EMBODIMENTS

To further clarify the objectives, technical schemes, and advantages of the present invention, the following sections offer a detailed description of the present invention in combination with the embodiments and accompanying drawings. It should be understood that the embodiments described herein are intended only to illustrate and not to limit the invention.

In an embodiment of the present invention, after receiving on-demand signals from users, the positioning system locks in the frequency at which users receive programs, compares the pre-stored area code with the TSID broadcasted by the locked frequency, and judges if the locked frequency is valid; if yes, the positioning is successful.

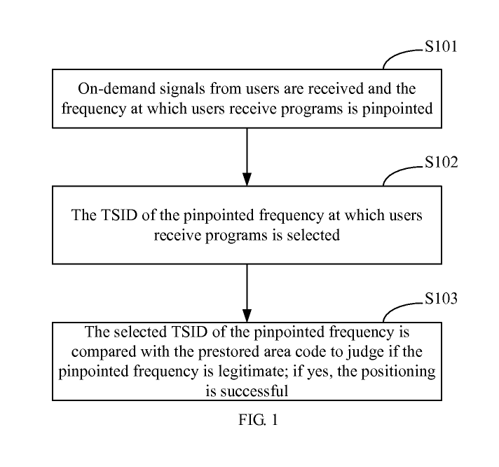

FIG. 1 is a flowchart of the method of positioning digital television receiving terminals provided in an embodiment of the present invention.

In Step S101: the on-demand signal from a user is received and the frequency at which the user receive programs is pinpointed.

In addition, a step of acquiring and prestoring the area code precedes step S101, and comprises: judging if the stored area code is the original area code; if yes, acquiring the mask of the local area code and the list of broadcast frequencies of the TSID from the front end; acquiring one by one the TSIDs broadcasted by the broadcast frequencies in the list, selecting an edge area code as the area code, or selecting an area code closest to the edge when there is no edge area code available.

The area code mask refers to a value containing one or several digits set differently from the TSID for area code identification, for the purpose of distinguishing this TSID from the TSIDs of DTV/NVOD in the area; this value is the area code mask of the related area. The 4 most significant digits of the TSID for area code identification are selected in the embodiment of the present invention as the area code mask. The TSID indicates the TSID for area code identification.

More specifically, a step of providing a leveled deployment in each area precedes the step of acquiring and prestoring the edge area code, further comprising: setting the area code mask for each area; setting different levels within each area by setting a parent area code and a sub-area code for each area, and using the parent area code or sub-area code as the TSID. To implement tree-like positioning in digital network distribution, each area is divided into three levels in the embodiment of the invention, with the area code of the last level in each area being the edge area code. However, in other embodiments of the invention, each area may be divided into two levels or more than three levels.

The parent area and the sub-area are defined in the embodiment of the present invention, with the TSID divided into 4 4-bit numbers, the 4 most significant digits being the area code mask, the following 3 4-bit digits being the real area code, the TSID with minimum 4 least significant digits of “0” being the parent area code, and the TSID with the 4 least significant digits other than “0” being the edge area code. If the parent area code is ‘a’, and the sub-area code is ‘b’, after the “AND” operation is performed between ‘a’ and ‘b’, the result is ‘a’, i.e, the relationship between ‘a’ and ‘b’ is: a&b=a, and the resources in the parent area can be used by the sub-area. Taking the three-grade area for example: setting the area code mask of a city at 8, then the area code of its central area is 0×8000, the area code of an edge area may be 0×8111, the parent area code of this edge area code is 0×8110, the parent area code of this parent area code is 0×8100, the parent area code of 0×8100 is 0×8000, i.e the central area.

In Step S102: The TSID broadcasted by the locked frequency at which users receive programs is selected.

The details of step S102 provided in the embodiments of the invention are: among all the TSIDs broadcasted by the locked frequency at which users receive programs, the TSID with the area code mask is selected as the TSID of this frequency.

In addition, when no TSID of the locked frequency is available, the user is prompted to reacquire the area code as shown in the embodiments of the invention.

In Step S103: The TSID broadcasted by the locked frequency and the pre-stored area code are compared to judge if the locked frequency at which users receive programs is valid; if yes, the positioning is successful.

In the embodiment of the present invention, if the pre-stored area code is AreaCode, and the TSID of the locked frequency is TSID, the step of judging if the locked frequency is valid further comprises: when an “AND” operation is performed between the pre-stored area code and the TSID of the locked frequency at which users receive programs, the result is not the TSID of the locked frequency, i.e TSID&AreaCode!=TSID. If the TSID is not the parent area code of the pre-stored area code, then the locked frequency at which users receive program is not valid, and the user is prompted to reacquire the area code; otherwise, the locked frequency is judged to be valid.

In addition, when the locked frequency at which users receive programs is judged to be valid, the method of positioning in the embodiments of the present invention may further comprise: judging if the pre-stored area code is normal; if yes, the positioning is successful; otherwise, the area code shall be updated so that the positioning can be successful.

If the pre-stored area code is AreaCode, and the TSID of the locked frequency is TSID, then the step of judging if the pre-stored area code is normal further comprises: after the “AND” operation is performed between the pre-stored area code and the TSID of the locked frequency, and the result is the TSID of the locked frequency, i.e TSID&AreaCode=TSID, the pre-stored area code is judged to be normal, and the positioning is successful; after the “AND” operation, when the result is the pre-stored area code, i.e TSID&AreaCode=AreaCode, it indicates the pre-stored area code has been subdivided, the pre-stored area code is judged to be abnormal; then the area code should be updated so that the updated area code is the TSID of the locked frequency, and the positioning is successful.

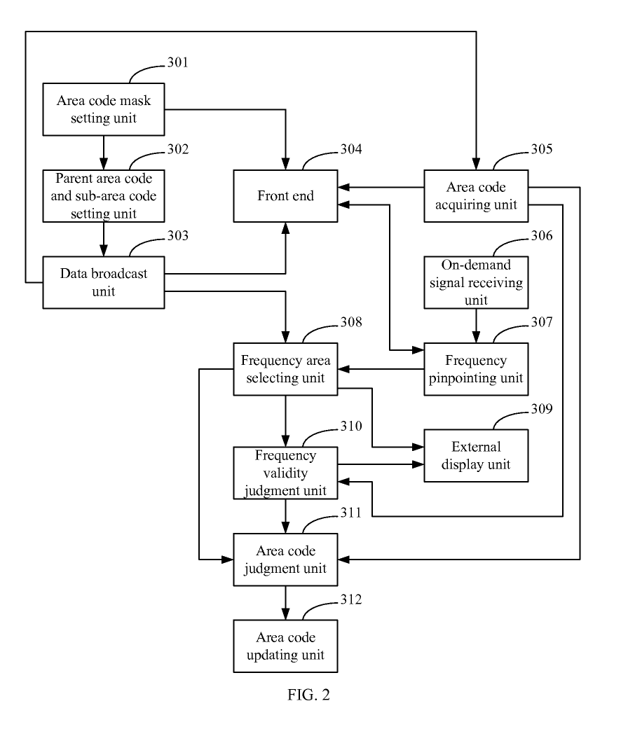

FIG. 2 shows a structure of the system for positioning digital television receiving terminals provided in an embodiment of the present invention, but only the part related to the embodiment of the invention is shown herein for convenient illustration. Area code mask setting unit 301 is configured to set the area code mask of each area and send it to parent area code and sub-area code setting unit 302 and front end 304. According to the received area code mask, parent area code and sub-area code setting unit 302 grades the areas by setting a parent area code and a sub-area code of each area, uses the set parent area code or sub-area code as the TSID, and broadcasts the TSID at different frequencies through data broadcast unit 303. At the same time, data broadcast unit 303 transmits the list of broadcast frequencies of the TSID to front end 304.

Area code selecting unit 305 judges if the stored area code is the original area code, if yes, acquires the local area code mask and the list of broadcasting frequencies of the TSID from the front end 304, acquires one by one the TSIDs broadcasted by the frequencies in the list from data broadcast unit 303, selects an edge area code as the area code; when no edge area code is available, selects the area code closest to the edge, and transmits the selected area code to frequency legitimacy judgment unit 310 as the area code pre-stored in frequency legitimacy judgment unit 310.

On-demand signal receiving unit 306 receives the on-demand signals from users, and transmits them to frequency locking unit 307. Frequency locking unit 307 locks the frequency at which users receive programs by interacting with front end 304, and transmits the frequency to frequency area code selecting unit 308. Frequency area code selecting unit 308 selects the TSID broadcasted by data broadcast unit 303 at the frequency at which users receive programs, further comprising: among all the TSIDs broadcasted by data broadcast unit 303, frequency area code selecting unit 308 selects the TSID with an area code mask as the TSID of this frequency. Frequency area code selecting unit 308 transmits the selected TSID broadcasted by data broadcast unit 303 at the frequency at which users receive programs to frequency legitimacy judgment unit 310. In addition, if frequency area code selecting unit 308 fails to select the TSID broadcast by data broadcast unit 303 at the frequency at which users receive programs, external display unit 309 prompts the user to reacquire an area code.

Frequency validity judgment unit 310 compares the TSID selected by frequency area code selecting unit 308 with the pre-stored area code, and judges if the locked frequency at which users receive programs is valid. If the pre-stored area code is AreaCode, and the TSID of the locked frequency at which users receive programs is TSID, the step where frequency area code validity judgment unit 310 judges if the locked frequency is valid further comprises: after the “AND” operation is performed between the pre-stored area code and the TSID of the locked frequency, and the result is not the TSID of the locked frequency, i.e TSID&AreaCode!=TSID, the TSID of the locked frequency is not the parent area code of the pre-stored area code; frequency area code validity judgment unit 310 judges the locked frequency to be invalid, and prompts the user to reacquire an area code; otherwise, frequency area code validity judgment unit 310 judges the locked frequency at which users receive programs to be valid, and the positioning is successful.

In addition, the positioning system in the embodiment of the present invention may further comprise area code judgment unit 311, which also receives the area code selected by area code acquiring unit 305 as the pre-stored area code, and receives the TSID selected by frequency area code selecting unit 308. When judging the locked frequency at which users receive programs to be valid, frequency area code validity judgment unit 310 sends a signal to area code judgment unit 311. According to the received signal, the area code judgment unit 311 judges if the pre-stored area code is normal. If the pre-stored area code is AreaCode, and the TSID of the locked frequency at which users receive programs is TSID, the step where area code judgment unit 311 judges if the pre-stored area code is normal further comprises: after the “AND” operation is performed between the pre-stored area code and the TSID of the locked frequency, and the result is the TSID of the locked frequency, i.e TSID&AreaCode=TSID, the pre-stored area code is judged to be normal, and the positioning is successful; after the “AND” operation, when the result is the pre-stored area code, i.e TSID&AreaCode=AreaCode, it indicates the pre-stored area code has been subdivided; area code judgment unit 311 judges the pre-stored area code to be abnormal, and sends a signal to area code updating unit 312. Area code updating unit 312 updates the area code so that the updated area code is the TSIDs of the locked frequency at which users receive programs, and the positioning is successful.

The system for positioning digital television receiving terminals provided in the embodiment of the present invention can be software units, hardware units or software/hardware integrated units embedded in digital television receiving terminals.

During an embodiment of the present invention, the positioning system, after receiving on-demand signals from users, locks in the frequency at which users receive programs, compares the pre-stored area code with the TSID broadcasted by the locked frequency, and judges if the locked frequency is valid; if yes, the positioning is successful; therefore it avoids the trouble of scanning and acquiring the area code each time the user uses the service on-demand, shortens startup time and enhances applicability. Furthermore, the system divides each area into three levels and implements a tree-like network distribution; and when the pre-stored area code is subdivided, the system can automatically update the area code, featuring strong applicability.

It is understandable to those skilled in the art that all or part of the steps in the foregoing embodiments may be performed through hardware instructed by a program. The program may be stored in a computer-readable storage medium such as ROM/RAM, magnetic disk, and compact disk.

Although the invention is described through the foregoing exemplary embodiments, the invention is not limited to such embodiments. Any modifications, replacements and improvements to the invention without departing from the spirit and scope of the invention shall fall in the scope of protection defined by the following claims or their equivalents.

1. A method of positioning digital television receiving terminals, comprising:
locking a frequency at which users receive programs according to a received on-demand signal from the users;
determining a transport stream identifier of a frequency in the TSID broadcasted by a locked frequency; and
comparing the transport stream identifier with a pre-stored area code and judging if the locked frequency is valid; if yes, the positioning is successful.

2. The method of positioning digital television receiving terminals according to claim 1, wherein, before locking the frequency at which users receive programs according to received on-demand signals from the users, the method further comprises:
acquiring and prestoring the area code.

3. The method of positioning digital television receiving terminals according to claim 2, wherein the steps of acquiring and pre-storing area codes further comprises:
judging if the pre-stored area code is an original area code; if yes, acquiring from a front end an area code mask and a list of broadcast frequencies of the transport stream identifier; and
acquiring one by one the transport stream identifiers broadcasted by the broadcast frequencies in the list of broadcast frequencies.

4. The method of positioning digital television receiving terminals according to claim 2, wherein, preceding acquiring and pre-storing the area code, the method further comprises:
providing a leveled deployment in areas, including:
setting the area code mask of each area; and
dividing each area in different levels by setting a parent area code and a sub-area code for every area code.

5. The method of positioning digital television receiving terminals according to claim 1, wherein said judging if the locked frequency is valid further comprising:
When an “AND” operation is performed between the pre-stored area code and the transport stream identifier of the locked frequency, and when the result is not the transport stream identifier of the locked frequency, the locked frequency is judged as invalid; otherwise, the locked frequency is judged as valid.

6. The method of positioning digital television receiving terminals according to claim 1, wherein, after judging whether the locked frequency for users to receive programs is valid, the method further comprises:
further judging if the pre-stored area code is normal according to the judging result; if yes, the positioning is successful; otherwise, the area code should be updated for the positioning to be successful.

7. The method of positioning digital television receiving terminals according to claim 6, wherein the further judging whether the pre-stored area codes are normal based on proper judgment results further comprising:
When the “AND” operation is performed between the pre-stored area code and the transport stream identifier of the locked frequency, and the result is the transport stream identifier of the locked frequency, the pre-stored area code is judged to be normal, and the positioning is successful; when the “AND” operation is performed between the pre-stored area code and the transport stream identifier of the locked frequency, and the result is the pre-stored area code, the pre-stored area code is judged to be abnormal and needs to be updated. After the updated area code is the transport stream identifier of the locked frequency, the positioning is successful.

8. A system for positioning digital television receiving terminals, comprising:
an on-demand signal receiving unit, configured to receive on-demand signals from users;
a frequency locking unit, configured to lock a frequency at which users receive programs according to the on-demand signals from users received by the on-demand signal receiving unit;
a frequency area code selecting unit, configured to determine transport stream identifier of a frequency in the TSID broadcasted by the locked frequency at which users receive programs; and
a frequency legitimacy judgment unit, configured to compare the transport stream identifier determined by the frequency area code selecting unit with a pre-stored area code and to judge if the locked frequency is valid; if yes, the positioning is successful.

9. The system for positioning digital television receiving terminals according to claim 8, further comprising:
an area code acquiring unit, configured to judge if the stored area code is an original area code and, if yes, to acquire from a front end an area code mask and a list of broadcast frequencies of the transport stream identifier, to acquire one by one the transport stream identifiers broadcasted by the frequencies in the list of broadcast frequencies, to select an edge area code as the area code, and to prestore it in the frequency legitimacy judgment unit.

10. The system for positioning digital television receiving terminals according to claim 9, further comprising:
an area code mask setting unit, configured to set the area code mask of each area and send it to the front end;
a parent area code and sub-area code setting unit, configured to set a parent area code and a sub-area code for each area code according to the area code mask of each area set by the area mask code setting unit, and divide each area by levels; and
a data broadcast unit, configured to use the parent area code or the sub-area code set by the parent area code and sub-area code setting unit as the transport stream identifier, to broadcast the transport stream identifier at different frequencies, and to transmit the list of broadcast frequencies of the transport stream identifier to the front end.

11. The system for positioning digital television receiving terminals according to claim 8, further comprising:
an area code judgment unit, configured to compare the selected transport stream identifier of the locked frequency with the pre-stored area code when the frequency legitimacy judgment unit judges the locked frequency to be valid but before the positioning is successful, judge if the pre-stored area code is normal; if yes, the positioning is successful; otherwise send the area code update signal; and
an area code updating unit, configured to update the area code according to an area code update signal sent by the area code judgment unit so that the updated area code is the transport stream identifier of the locked frequency at which users receive programs, and the positioning is successful.

12. A digital television receiving terminal, comprising the system for positioning digital television receiving terminals according to claim 8.

13. The method of positioning digital television receiving terminals according to claim 2, wherein, after judging whether the locked frequency for users to receive programs is valid, the method further comprises:
further judging if the pre-stored area code is normal according to the judging result; if yes, the positioning is successful; otherwise, the area code should be updated for the positioning to be successful.

14. The method of positioning digital television receiving terminals according to claim 3, wherein, after judging whether the locked frequency for users to receive programs is valid, the method further comprises:
further judging if the pre-stored area code is normal according to the judging result; if yes, the positioning is successful; otherwise, the area code should be updated for the positioning to be successful.

15. The method of positioning digital television receiving terminals according to claim 4, wherein, after judging whether the locked frequency for users to receive programs is valid, the method further comprises:
further judging if the pre-stored area code is normal according to the judging result; if yes, the positioning is successful; otherwise, the area code should be updated for the positioning to be successful.

16. The method of positioning digital television receiving terminals according to claim 5, wherein, after judging whether the locked frequency for users to receive programs is valid, the method further comprises:
further judging if the pre-stored area code is normal according to the judging result; if yes, the positioning is successful; otherwise, the area code should be updated for the positioning to be successful.

17. The method of positioning digital television receiving terminals according to claim 13, wherein the further judging whether the pre-stored area codes are normal based on proper judgment results further comprising:
When the “AND” operation is performed between the pre-stored area code and the transport stream identifier of the locked frequency, and the result is the transport stream identifier of the locked frequency, the pre-stored area code is judged to be normal, and the positioning is successful; when the “AND” operation is performed between the pre-stored area code and the transport stream identifier of the locked frequency, and the result is the pre-stored area code, the pre-stored area code is judged to be abnormal and needs to be updated. After the updated area code is the transport stream identifier of the locked frequency, the positioning is successful.

18. A digital television receiving terminal, comprising the system for positioning digital television receiving terminals according to claim 9.

19. A digital television receiving terminal, comprising the system for positioning digital television receiving terminals according to claim 10.

20. A digital television receiving terminal, comprising the system for positioning digital television receiving terminals according to claim 11.
